(19) United States
(12) Patent Application Publication
(10) Pub. No.: US 2021/0079981 A1
(43) Pub. Date: Mar. 18, 2021

(54) MULTI-STAGE TRANSMISSION FOR ELECTRIC VEHICLE

(71) Applicants: Hyundai Motor Company, Seoul (KR); Kia Motors Corporation, Seoul (KR)

(72) Inventor: Jong Yun PARK, Hwaseong-si (KR)

(73) Assignees: Hyundai Motor Company, Seoul (KR); Kia Motors Corporation, Seoul (KR)

(21) Appl. No.: 16/739,715

(22) Filed: Jan. 10, 2020

(30) Foreign Application Priority Data
Sep. 18, 2019 (KR) 10-2019-0114658

(51) Int. Cl. F16H 3/12; F16H 3/089

(52) U.S. Cl. CPC F16H 3/12; F16H 3/085; F16H 3/089

(57) ABSTRACT

The multi-stage transmission for an electric vehicle may include an input shaft to which a motor is configured to be coupled; an output shaft mounted in parallel with the input shaft; N shift gear pairs mounted on the input shaft and the output shaft and circumscribed with each other, to form N gear shifting stages; 2N-2 engagement clutch mechanisms mounted to select any one of the shift gear pairs to allow a power transmittable state between the input shaft and the output shaft to be switched by an gear engagement; N-1 coupling gear pairs mounted on the input shaft and the output shaft and circumscribed with each other; and N-1 friction clutch mechanisms mounted to select a coupling gear pair to allow a power transmission between the input shaft and the output shaft to be continuously varied by a frictional force.

### CROSS REFERENCE TO RELATED APPLICATION

The present application claims priority to Korean Patent Application No. 10-2019-0114658 filed on Sep. 18, 2019, the entire contents of which is incorporated herein for all purposes by this reference.

### BACKGROUND OF THE PRESENT INVENTION

### Field of the Invention

The present invention relates a layer of a multi-stage transmission capable of being mounted on an electric vehicle.

### Description of Related Art

An electric vehicle is driven by use of a driving force of a motor, and the motor has excellent low-speed torque and wide rotation range, and so it is not impossible to construct a vehicle without a transmission, but a reducers or a transmission may be employed to reduce a weight and capacity of the motor and reduce manufacturing cost of the vehicle.

Therefore, a transmission employed in the electric vehicle is required to be constructed with simpler configuration and less weight, and a phenomenon such as torque interruption may not be occurred during gear-shifting.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a multi-stage transmission for an electric vehicle which can employ simple configuration and weight to reduce manufacturing cost of the electric vehicle as well as to enhance fuel efficiency (electric power consumption), and can prevent torque interruption from occurring during gear-shifting to secure smooth and stable gear-shifting feeling, and ultimately enhance merchantability of the electric vehicle.

In various aspects of the present invention, a multi-stage transmission for an electric vehicle of the present invention may include an input shaft to which a motor is configured to be coupled; an output shaft mounted in parallel with the input shaft; N shift gear pairs mounted on the input shaft and the output shaft and circumscribed with each other, to form a series of N gear shifting stages; 2N-2 engagement clutch mechanisms mounted to select any one of the shift gear pairs to allow a power transmittable state between the input shaft and the output shaft to be switched by an gear engagement; N-1 coupling gear pairs mounted on the input shaft and the output shaft and circumscribed with each other; and N-1 friction clutch mechanisms mounted to select any one of the coupling gear pairs to allow a power transmission between the input shaft and the output shaft to be continuously varied by a frictional force.

Starting from the gear ratio of the coupling gear pair which is smaller than the smallest one of the gear ratios of the shift gear pairs, the coupling gear pairs in turn may have the gear ratios which are between the gear ratios of the corresponding adjacent shift gear pairs, respectively.

The engagement clutch mechanism may include a dog clutch and a synchronizer; the shift gear pair having the largest gear ratio among the N shift gear pairs may be configured to allow the power transmittable state between the input shaft and the output shaft to be switched by the synchronizer; the shift gear pair having the smallest gear ratio among the N shift gear pairs may be configured to allow the power transmittable state between the input shaft and the output shaft to be switched by the dog clutch; and the remaining shift gear pair having a median gear ratio among the N shift gear pairs may be configured to allow the power transmittable state between the input shaft and the output shaft to be switched by both the synchronizer and the dog clutch.

The shift gear pair having the largest gear ratio and the shift gear pair having the smallest gear ratio among the N shift gear pairs may be mounted on the outermost sides of the shift gear pairs mounted adjacent to each other; and the engagement clutch mechanism may be mounted to move a sleeve towards both sides between the shift gear pairs mounted adjacent to each other to allow a power transmittable state of each of both shift gear pairs to be switched.

The friction clutch mechanism may include a cone clutch and mounted such that a cone ring is moved to both sides between the coupling gear pairs mounted adjacent to each other to allow a frictional force of both the coupling gear pairs to be continuously changed.

The shift gear pairs may include a first-stage shift gear pair, a second-stage shift gear pair and a third-stage shift gear pair to form a series of three (3) gear shifting stages.

Torque interruption in which the torque transmitted from the input shaft to the output shaft is interrupted while gear-shifting is performed does not occur during all the gear-shifting process as described above, and so that the exemplary embodiment of the present invention can secure excellent gear-shifting feeling to significantly enhance marketability of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a structural view of a multi-stage transmission for an electric vehicle according to an exemplary embodiment of the present invention;

FIG. 2 is a view sequentially illustrating that the transmission of FIG. 1 performs a power-on upshift from a first stage to a second stage;

FIG. 3 is a view sequentially illustrating that the transmission of FIG. 1 performs the power-on upshift from the second stage to a third stage;

FIG. 4 is a view sequentially illustrating that the transmission of FIG. 1 performs a power-on downshift from the third stage to the second stage;

FIG. 5 is a view sequentially illustrating that the transmission of FIG. 1 performs the power-on downshift from the second stage to the first stage; and

FIG. 6 is a view sequentially illustrating that the transmission of FIG. 1 performs the power-on downshift from the third stage to the first stage.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

A multi-stage transmission according to the exemplary embodiment of the present invention will be described below with reference to the accompanying drawings.

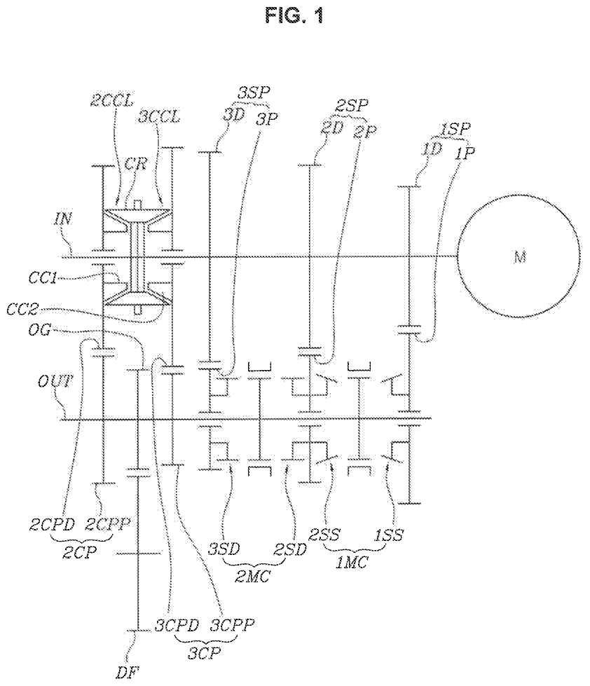

Referring to FIG. 1, a multi-stage transmission for an electric vehicle, according to an exemplary embodiment of the present invention includes an input shaft IN to which a motor M is coupled; an output shaft OUT mounted in parallel with the input shaft IN; N shift gear pairs mounted on the input shaft IN and the output shaft OUT and circumscribed with each other, to form a series of N gear shifting stages; 2N-2 engagement clutch mechanisms mounted to select any one of the shift gear pairs to allow a power transmittable state between the input shaft IN and the output shaft OUT to be switched by an gear engagement; N-1 coupling gear pairs mounted on the input shaft IN and the output shaft OUT and circumscribed with each other; and N-1 friction clutch mechanisms mounted to select any one of the coupling gear pairs to allow a power transmission between the input shaft IN and the output shaft OUT to be continuously varied by a frictional force.

In other words, the present invention forms the transmission for the electric vehicle which can implement a series of N gear shifting stages, performs gear-shifting using the N shift gear pairs and the 2N-2 engagement clutch mechanisms, and prevents a torque interruption from being generated during the gear shifting, using the N-1 coupling gear pairs and the N-1 friction clutch mechanisms.

N is substantially equal to or greater than 3, and in the exemplary embodiment shown in FIG. 1, N is 3, and the shift gear pairs includes a first-stage shift gear pair 1SP, a second-stage shift gear pair 2SP and a third-stage shift gear pair 3SP to form a series of three (3) gear shifting stages.

In the configuration shown in FIG. 1, therefore, the four engagement clutch mechanisms (2×3−2=4) are provided, and the two coupling gear pair and the two friction clutch mechanisms are provided.

Starting from the gear ratio of the coupling gear pair which is smaller than the smallest one of the gear ratios of the shift gear pairs, the coupling gear pairs in turn have the gear ratios which are between the gear ratios of the corresponding adjacent shift gear pairs, respectively.

That is, in the exemplary embodiment of FIG. 1, since the two coupling gear pairs include a second-stage coupling gear pair 2CP having a relatively large gear ratio and a third-stage coupling gear pair 3CP having a relatively small gear ratio, and the gear ratios of the shift gear pairs have a relation of [the gear ratio of the first-stage shift gear pair 1SP >the gear ratio of the second-stage shift gear pair 2SP>the gear ratio of the third-stage shift gear pair 3SP], a gear ratio relation of the coupling gear pairs and the shift gear pairs is [the gear ratio of the first-stage shift gear pair 1SP>the gear ratio of the second-stage shift gear pair 2SP>the gear ratio of the second-stage coupling gear pair 2CP>the gear ratio of the third-stage shift gear pair 3SP>the gear ratio of the third-stage coupling gear pair 3CP].

Here, a difference in gear ratio between the gear ratio of the second-stage shift gear pair 2SP and the gear ratio of the second-stage coupling gear pair 2CP is set to be small in the range of about 0.01 to 0.05, and it is also preferable that a difference in gear ratio between the gear ratio of the third-stage shift gear pair 3SP and the gear ratio of the third-stage coupling gear pair 3CP is set to be small in the range of about 0.01 to 0.05.

Meanwhile, the engagement clutch mechanism includes a dog clutch and a synchronizer; among the N shift gear pairs, the shift gear pair having the largest gear ratio is configured to allow the power transmittable state between the input shaft IN and the output shaft OUT to be switched by the synchronizer; among the N shift gear pairs, the shift gear pair having the smallest gear ratio is configured to allow the power transmittable state between the input shaft IN and the output shaft OUT to be switched by the dog clutch; and among the N shift gear pairs, the remaining shift gear pair having a median gear ratio is configured to allow the power transmittable state between the input shaft IN and the output shaft OUT to be switched by both the synchronizer and the dog clutch.

In the exemplary embodiment of FIG. 1, that is, the first-stage shift gear pair 1SP is configured to allow the power transmittable state to be switched by a first-stage synchronizer 1SS, the third-stage shift gear pair 3SP is configured to allow the power transmittable state to be switched by a third-stage dog clutch 3SD, and the second-stage shift gear pair 2SP is configured to allow the power transmittable state to be switched by a second-stage synchronizer 2SS and a second-stage dog clutch 2SD.

For reference, the first-stage shift gear pair 1SP includes a first-stage driving gear 1D whose rotation is constrained to the input shaft IN, and a first-stage driven gear 1P rotatably mounted on the output shaft OUT; the second-stage shift gear pair 2SP includes a second-stage driving gear 2D whose rotation is constrained to the input shaft IN, and a second-stage driven gear 2P rotatably mounted on the output shaft OUT; and the third-stage shift gear pair 3SP includes a third-stage driving gear 3D whose rotation is constrained to the input shaft IN, and a third-stage driven gear 3P rotatably mounted on the output shaft OUT.

Furthermore, the second-stage coupling gear pair 2CP includes a second-stage coupling driving gear 2CPD rotatably mounted on the input shaft IN and a second-stage coupling driven gear 2CPP whose rotation is constrained to the output shaft OUT, and the third-stage coupling gear pair 3CP includes a third-stage coupling driving gear 3CPD rotatably mounted on the input shaft IN and a third-stage coupling driven gear 3CPP whose rotation is constrained to the output shaft OUT.

Among the N shift gear pairs, the shift gear pair having the largest gear ratio and the shift gear pair having the smallest gear ratio are mounted on the outermost sides of the shift gear pairs mounted adjacent to each other; and the engagement clutch mechanism is mounted to move a sleeve towards both sides between the shift gear pairs mounted adjacent to each other to allow the power transmittable state of each of both shift gear pairs to be switched.

That is, in the exemplary embodiment of FIG. 1, the first-stage shift gear pair 1SP, the second-stage shift gear pair 2SP and the third-stage shift gear pair 3SP are mounted adjacent to each other, and among them, the first-stage shift gear pair 1SP having the largest gear ratio and the third-stage shift gear pair 3SP having the smallest gear ratio are mounted on the outermost side thereof. Furthermore, the engagement clutch mechanisms includes a first engagement clutch mechanism 1MC mounted between the first-stage driven gear 1P and the second-stage driven gear 2P and provided with the first-stage synchronizer 1SS and the second-stage synchronizer 2SS at both sides, respectively, and a second engagement clutch mechanism 2MC mounted between the second-stage driven gear 2P and the third-stage driven gear 3P and provided with the second-stage dog clutch 2SD and the third-stage dog clutch 3SD at both sides, respectively.

For reference, the “synchronizer” used herein indicates a device including a synchronizer ring provided between a hub and a clutch gear to synchronize speeds of a sleeve and the clutch gear first when the sleeve, which is being slid in an axial direction with respect to the hub, is engaged with the clutch gear coupled integrally to a shifting stage gear for forming a gear shifting stage, and the “dog clutch” refers to a device in which the synchronizer ring performing synchronization action is excluded from the configuration of the above-mention synchronizer. Here, the configurations of the synchronizer and the dog clutch are known in the art to which an exemplary embodiment of the present invention pertains.

In more specifically, therefore, the first-stage synchronizer 1SS of the first engagement clutch mechanism 1MC is configured such that which when the sleeve, which is being slid in the axial direction with respect to the hub whose rotation is constrained to the output shaft OUT, is moved to a right side, the hub and the first-stage driven gear 1P are synchronized by the synchronizer ring (not shown in the drawing) and the sleeve is then engaged with the clutch gear integrally provided on the first-stage driven gear 1P to couple the first-stage driven gear 1P to the output shaft OUT so that a power transmitted from the input shaft IN is speed-changed into the first-stage by the first-stage driving gear 1D and the first-stage driven gear 1P and is then transmitted to the output shaft OUT.

Likewise, of course, the second-stage synchronizer 2SS is configured such that when the sleeve of the first engagement clutch mechanism 1MC is moved to a left side, the hub and the second-stage driven gear 2P are synchronized by the synchronizer ring, and the sleeve is then engaged with the clutch gear integrally provided on the second-stage driven gear 2P to couple the second-stage driven gear 2P to the output shaft OUT.

Furthermore, the second-stage dog clutch 2SD is configured such that when the sleeve of the second engagement clutch mechanism 2MC is moved to the right side, the sleeve may be engaged with the clutch gear of the second-stage driven gear 2P without synchronizing action of the synchronizer ring, to couple the second-stage driven gear 2P to the output shaft OUT, and the third-stage dog clutch 3SD is configured such that when the sleeve is moved to the left side without synchronizing action of the synchronizer ring, the sleeve may be engaged with the third-stage driven gear 3P to form a state in which the third-stage driven gear 3P is coupled to the output shaft OUT.

On the other hand, the friction clutch mechanism includes a cone clutch and mounted such that a cone ring is moved to both sides between the coupling gear pairs mounted adjacent to each other to allow a frictional force of both the coupling gear pairs to be continuously changed.

In other words, the friction clutch mechanism in FIG. 1 includes a second-stage cone clutch 2CCL including a cone ring CR and a clutch cone CC1 of the second-stage coupling driving gear 2CPD mounted on the input shaft IN, and a third-stage cone clutch 3CCL including the cone ring CR and a clutch cone CC2 of the third-stage coupling driving gear 3CPD, so that when the cone ring CR is moved to the left side, a frictional force between the second-stage coupling driving gear 2CPD and the cone ring CR is continuously varied to transmit the power of the input shaft IN to the output shaft OUT through the second-stage coupling driving gear 2CPD and the second-stage coupling driven gear 2CPP, and when the cone ring CR is moved to the right side, a frictional force between the third-stage coupling driving gear 3CPD and the cone ring CR is continuously varied to transmit the power of the input shaft IN to the output shaft OUT through the third-stage coupling driving gear 3CPD and the third-stage coupling driven gear 3CPP.

For reference, FIG. 1 illustrates that an output gear OG is mounted on the output shaft OUT to take-off the power, which is being transmitted to the output shaft OUT, through a differential DF.

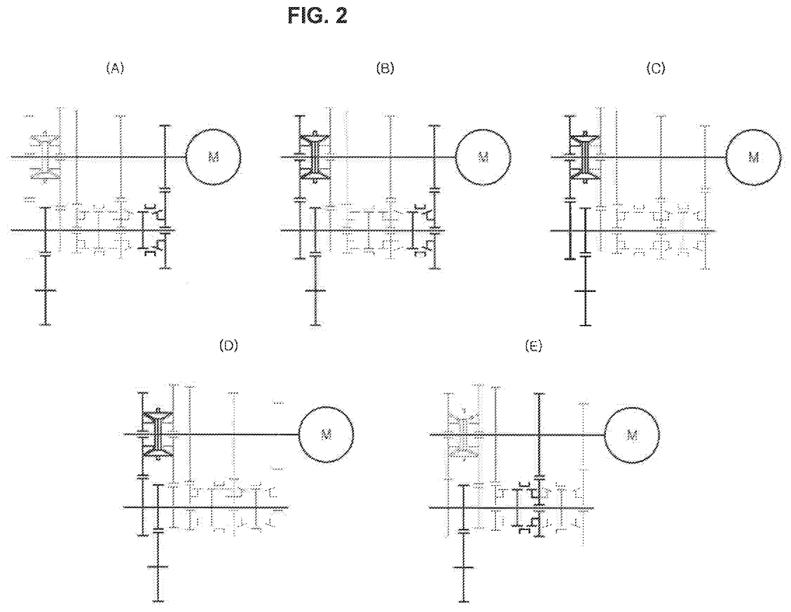

FIG. 2 is a view sequentially illustrating that the transmission of FIG. 1 performs a power-on upshift from a first stage to a second stage, a state of an in FIG. 2 is a state in which the sleeve of the first engagement clutch mechanism 1MC is moved to the right side to couple the first-stage driven gear 1P to the output shaft OUT and the power of the motor is speed-changed through the first-stage driving gear 1D and the first-stage driven gear 1P so that the output shaft OUT takes-off the first-staved power to the differential DF through the output gear OG.

A state of B in FIG. 2 is a state in which, by moving the cone ring CR to the left side, the second-stage cone clutch 2CCL generates the frictional force to allow the power to be transmitted the output shaft OUT even through the second-stage coupling driving 2CPP and the second-stage coupling driven gear 2CCP.

A state of C in FIG. 2 is a state in which the power is continuously transmitted to the output shaft OUT through the second-stage cone clutch 2CCL to be maintained in the first stage, while the sleeve of the first engagement clutch mechanism 1MC is released in a neutral state.

A state of D in FIG. 2 is a state in which the second-stage cone clutch 2CCL is almost completely coupled, and therefore, after adjusting the speed of the motor M, the sleeve of the second engagement clutch mechanism 2MC is moved to the right side to couple the second-stage dog clutch 2SD is coupled.

The reason why the dog clutch and not the synchronizer, is provided between the sleeve of the second engagement clutch mechanism 2MC and the third-stage driven gear 2P is that if the gear ratio of the second-stage shift gear pair 2SP differs from that of the second-stage coupling gear pair 2CP, when gear-shifting is performed from another gear shifting stage to the second stage while the torque interruption is removed by coupling the second-stage cone clutch 2CCL, slight relative speed is generated between the sleeve of the second engagement clutch mechanism 2MC and the second-stage driven gear 2P due to the above-mentioned difference in gear ratio, in the instant case, it is difficult to overcome the present relative speed and perform the synchronization using a capacity of the synchronizer ring forming the synchronizer so that this rather makes it impossible to engage the sleeve with the clutch gear of the second-stage driven gear 2P.

Therefore, it is desirable that, by generating the difference in gear ratio between the gear ratio of the second-stage shift gear pair 2SP and the gear ratio of the second-stage coupling gear pair 2CP only in a very small range as described above, in a state in which the second-stage cone clutch 2CCL is coupled, slight relative speed is generated, but they are almost synchronized to allow the sleeve of the second engagement clutch mechanism 2MC to be engaged with the clutch gear of the second-stage driven gear 2P as it is without a synchronizing action caused by the synchronizer ring.

A state of E in FIG. 2 indicates a second-stage driving state in which the second-stage cone clutch 2CCL is released from the D state to transmit the power of the motor M to the output shaft OUT through the second-stage driving gear 2D and the second-stage driven gear 2P.

In the above gear-shifting process, while the power is continuously transmitted to the output shaft OUT through the second-stage cone clutch CCL, the sleeve of the first engagement clutch mechanism 1MC is released to a neutral stage, and the sleeve of the second engagement clutch mechanism 2MC is coupled to the second-stage dog clutch 2SD, and so gear-shifting is performed without a torque interruption.

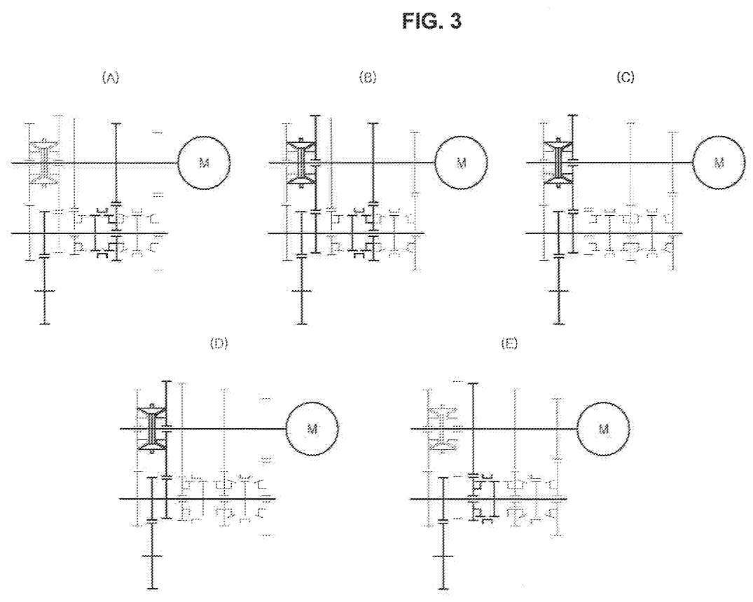

FIG. 3 is a view sequentially illustrating that the transmission of FIG. 1 performs the power-on upshift from the second stage to the third stage, the present process is described below.

A state of an in FIG. 3 is a second-stage driving state, when a command for gear-shifting to the third stage is generated, the third-stage cone clutch 3CCL is slipped as shown in a state of B, and so that the power of the motor M is also started to be transmitted to the output shaft OUT even through the third-stage coupling driving gear 3CPD and the third-stage coupling driven gear 3CPP, and at the same time, the sleeve of the second engagement clutch mechanism 2MC is changed to the natural stage as shown in a state C to release the second-stage dog dutch 2SD coupling the second-stage driven gear 2P to the output shaft OUT.

Since the present state is the power-on upshift state in which gear-shifting is being performed in a situation in which a driver steps on an accelerator pedal to actively apply the power from the motor M to the output shaft OUT, when the third-stage cone clutch 3CC is slipped to gradually increase a frictional force, the third-stage coupling driven gear 3CPP becomes faster than the second-stage driven gear 2P, and so that the power transmitted so far through the second-stage driving gear 2D and the second-stage driven gear 2P is started to be transmitted through the third-stage coupling driving gear 3CPD and the third-stage coupling driven gear 3CPP. At the instant time, if the second-stage dog clutch 2SD coupling the second-stage driven gear 2P to the output shaft OUT is released, the dog clutch is softly and smoothly released.

A state of D in FIG. 3 is a state in which the third-stage cone clutch 3CCL is almost completely coupled, and therefore, after adjusting the speed of the motor M, the sleeve of the second engagement clutch mechanism 2MC is moved to the left side to couple the third-stage dog clutch 3SD is coupled.

The reason why the dog clutch and not the synchronizer, is provided between the sleeve of the second engagement clutch mechanism 2MC and the third-stage driven gear 3P is also that if the gear ratio of the third-stage shift gear pair 3SP differs from that of the third-stage coupling gear pair 3CP, when gear-shifting is performed to the third stage while the torque interruption is removed by coupling the third-stage cone clutch 3CCL, slight relative speed is generated between the sleeve of the second engagement clutch mechanism 2MC and the third-stage driven gear 3P due to the above-mentioned difference in gear ratio, in the instant case, it is difficult to overcome the present relative speed and perform the synchronization using a. capacity of the synchronizer ring forming the synchronizer so that this makes it impossible to engage the sleeve with the clutch gear of the third-stage driven gear 3P.

Therefore, it is desirable that, by generating the difference in gear ratio between the gear ratio of the third-stage shift gear pair 3SP and the gear ratio of the third-stage coupling gear pair 3CP only in a very small range as described above, in a state in which the third-stage cone clutch 3CCL is coupled, slight relative speed is generated, but they are almost synchronized to allow the sleeve of the second engagement clutch mechanism 2MC to be engaged with the clutch gear of the third-stage driven gear 3P as it is without a synchronizing action caused by the synchronizer ring.

A state of E in FIG. 3 indicates a third-stage driving state in which the third-stage cone clutch 3CCL is released to transmit the power from the motor M to the output shaft OUT through only the third-stage shift gear pair 3SP.

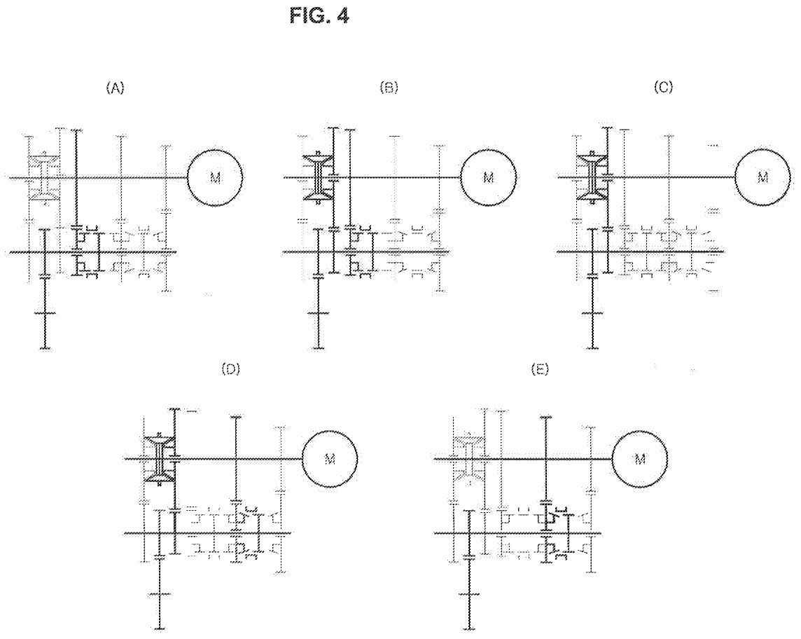

FIG. 4 is a view sequentially illustrating that the transmission of FIG. 1 performs the power-on downshift from the third stage to the second stage, the present process is described below.

A state of an in FIG. 4 is a state the power of the motor M is transmitted to the output shaft OUT through the third-stage shift gear pair 3SP, when a command for gear-shifting to the second stage is generated, the third-stage cone clutch 3CCL is coupled as shown in a state of B, and so that the power is transmitted to the output shaft OUT even through the third-stage coupling gear pair 3CP.

As a frictional force of the third-stage cone clutch 3CCL is increased, since the gear ratio of the third-stage coupling gear pair 3CP is slightly smaller than that of the third-stage shift gear pair 3SP, the power transmitted through the third-stage shift gear pair 3SP is gradually transmitted by the third-stage coupling gear pair 3CP, and so there comes a time when the third-stage dog clutch 3SD may be easily released, and at the present time, the sleeve of the second engagement clutch mechanism 2MC is moved to the neutral stage to release the third-stage dog clutch 3SD as shown in the state of C.

A state of D is a state in which a speed of the second-stage driven gear 2P is synchronized to a speed of the output shaft OUT using margin torque of the motor, while the sleeve of the first engagement clutch mechanism 1MC is moved to the left side and the second-stage synchronizer 2SS is coupled to couple the second-stage driven gear 2P to the output shaft OUT. A state of E indicates that the third-stage cone clutch 3CCL is released to form the second-stage driving state.

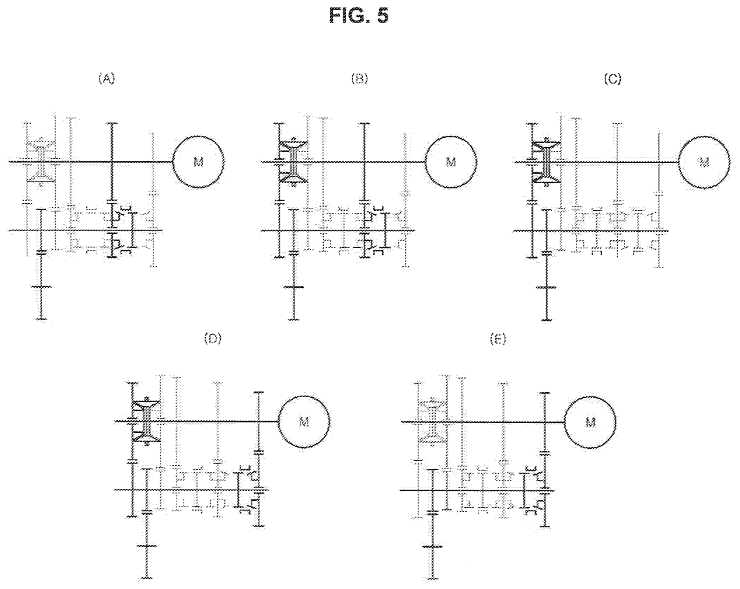

FIG. 5 is a view sequentially illustrating that the transmission of FIG. 1 performs the power-on downshift from the second stage to the first stage. In a driving state such as a state of A in FIG. 5, when a command for gear-shifting to the first is generated, the second-stage cone clutch 2CCL is slipped as shown in a state of B.

As a frictional force of the second-stage cone clutch 2CCL is increased, since the gear ratio of the second-stage coupling gear pair 2CP is slightly smaller than that of the second-stage shift gear pair 2SP, the power transmitted through the second-stage shift gear pair 2SP is gradually transmitted by the second-stage coupling gear pair 2CP, and so there comes a time when the second-stage synchronizer 2SS may be easily released, and at the present time, the sleeve of the first engagement clutch mechanism 1MC is moved to the neutral stage to release the second-stage synchronizer 2SS as shown in the state of C.

Accordingly, as shown in the state of D, a speed of the first-stage driven gear 1P is synchronized to a speed of the output shaft OUT using margin torque of the motor, while the sleeve of the first engagement clutch mechanism 1MC is moved to the right side, the first-stage synchronizer 1SS is coupled to couple the first-stage driven gear 1P to the output shaft OUT, and the second-stage cone clutch 2CCL is released, and a result, the first-stage driving state is realized as shown in a state of E.

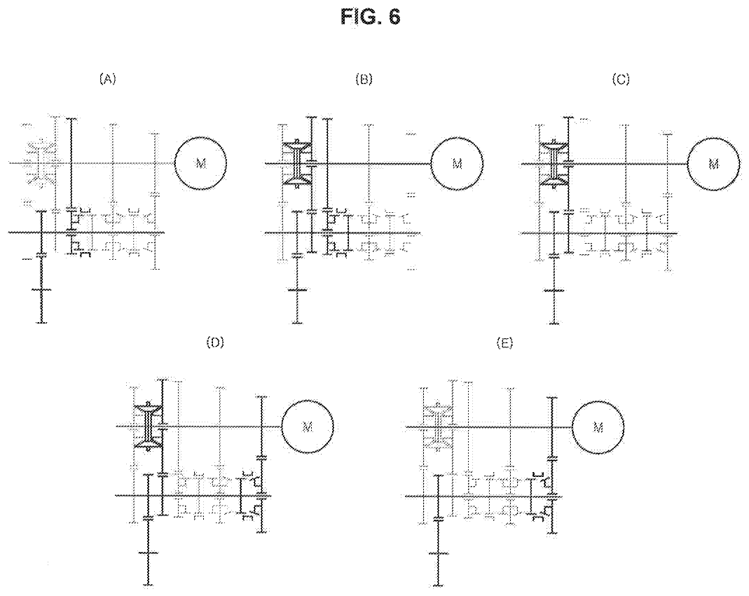

FIG. 6 is a view sequentially illustrating that the transmission of FIG. 1 performs the power-on downshift from the third stage to the first stage.

In a third-stage driving state such as a state of A, when a command for gear-shifting to the first stage is generated, the third-stage cone clutch 3CCL is slipped as shown in a state of B, and the sleeve of the second engagement mechanism 2MC is moved to the neutral state to release the third-stage dog clutch 3SD.

Accordingly, as shown in the state of D, a speed of the first-stage driven gear 1P is synchronized to a speed of the output shaft OUT using margin torque of the motor, while the sleeve of the first engagement clutch mechanism 1MC is moved to the right side, the first-stage synchronizer 1SS is coupled to couple the first-stage driven gear 1P to the output shaft OUT, and the third-stage cone clutch 3CCL is released, and as a result, the first-stage driving state is realized as shown in a state of E.

The present invention can reduce the cost of electric vehicle with a simple configuration and weight, and improve electric power consumption, while eliminating torque interruption during gear-shifting, ensuring a smooth and stable gear-shifting feeling, and ultimately enhancing merchantability of an electric vehicle.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A multi-stage transmission for a vehicle, the multi-stage transmission comprising:
an input shaft to which a motor is configured to be coupled;
an output shaft mounted in parallel with the input shaft;
a plurality of N shift gear pairs mounted on the input shaft and the output shaft to form a series of N gear shifting stages;
2N-2 engagement clutch mechanisms mounted to select one of the plurality of N shift gear pairs to allow a power transmittable state between the input shaft and the output shaft to be switched by an gear engagement;
a plurality of N-1 coupling gear pairs mounted on the input shaft and the output shaft; and
N-1 friction clutch mechanisms mounted to select one of the plurality of N-1 coupling gear pairs to allow a power transmission between the input shaft and the output shaft to be varied by a frictional force.

2. The multi-stage transmission of claim 1, wherein, starting from a gear ratio of the plurality of N-1 coupling gear pairs which is smaller than a smallest one of gear ratios of the plurality of N shift gear pairs, coupling gear pairs in turn have gear ratios which are between gear ratios of a corresponding adjacent shift gear pair among the plurality of N-1 coupling gear pairs, respectively.

3. The multi-stage transmission of claim 2,
wherein the 2N-2 engagement clutch mechanisms include a dog clutch and a synchronizer; and
wherein the plurality of N-1 coupling gear pairs includes:
a first shift gear pair having a largest gear ratio among the plurality of N shift gear pairs, the first shift gear pair configured to allow the power transmittable state between the input shaft and the output shaft to be switched by the synchronizer;
a second shift gear pair having a smallest gear ratio among the plurality of N shift gear pairs, the second shift gear pair configured to allow the power transmittable state between the input shaft and the output shaft to be switched by the dog clutch; and
a remaining shift gear pair having a median gear ratio among the plurality of N shift gear pairs, the remaining shift gear pair configured to allow the power transmittable state between the input shaft and the output shaft to be switched by the synchronizer and the dog clutch.

4. The multi-stage transmission of claim 3,
wherein the first shift gear pair having. the largest gear ratio and the second shift gear pair having the smallest gear ratio among the plurality of N shift gear pairs are mounted on outermost sides of the plurality of N shift gear pairs mounted adjacent to each other; and
wherein the 2N-2 engagement clutch mechanisms are mounted to move a sleeve towards a first side and a second side between the plurality of N shift gear pairs mounted adjacent to each other to allow a power transmittable state of each of two shift gear pairs among the plurality of N shift gear pairs to be switched.

5. The multi-stage transmission of claim 3, wherein the N-1 friction clutch mechanisms include a cone clutch and mounted such that a cone ring is moved to first and second sides between the plurality of N-1 coupling gear pairs mounted adjacent to each other to allow a frictional force of the plurality of N-1 coupling gear pairs to be continuously changed.

6. The multistage transmission of claim 1, wherein the plurality of N shift gear pairs includes a first-stage shift gear pair, a second-stage shift gear pair and a third-stage shift gear pair to form a series of three gear shifting stages.

7. The multi-stage transmission of claim 1, wherein the plurality of N shift gear pairs includes:
a first shift gear pair having a first shift driving gear fixed to the input shaft and a first shift driven gear rotatably mounted on the output shaft and gear-meshed with the first shift driving gear;
a second shift gear pair having a second shift driving gear fixed to the input shaft and a second shift driven gear rotatably mounted on the output shaft and gear-meshed with second shift driving gear; and
a third shift gear pair having a third shift driving gear fixed to the input shaft and a third shift driven gear rotatably mounted on the output shaft and gear-meshed with the third shift driving gear.

8. The multi-stage transmission of claim 7, wherein the 2N-2 engagement clutch mechanisms include:
a first synchronizer provided to the first shift driven gear to selectively coupled the first shift driven gear to the output shaft;
a second synchronizer provided to a first side of the second shift driven gear to selectively couple the second shift driven gear to the output shaft;
a first dog clutch provided to a second side of the second shift driven gear to selectively couple the second shift driven gear to the output shaft; and
a second dog clutch provided to a side of the third shift driven gear to selectively couple the third shift driven gear to the output shaft.

9. The multi-stage transmission of claim 7, wherein the N-1 friction clutch mechanisms include:
a first cone clutch including a first clutch cone;
a second cone clutch including a second clutch cone; and
a cone ring slidably on the input shaft so that the cone ring is selectively coupled to the first clutch cone and to the second clutch cone.

10. The multi-stage transmission of claim 9, wherein the plurality of N-1 coupling gear pair includes:
a first coupling gear pair having a first coupling driving gear rotatably mounted to the input shaft and a first coupling driven gear fixed to the output shaft and gear-meshed with the first coupling driving gear, wherein the first clutch cone of the first cone clutch is mounted to the first coupling driving gear; and
a second coupling gear pair having a second coupling driving gear rotatably mounted to the input shaft and a second coupling driven gear fixed to the output shaft and gear-meshed with the second coupling driving gear, wherein the second clutch cone of the second cone clutch is mounted to the second coupling driving gear.

11. The multi-stage transmission of claim 10, wherein an output gear is mounted to the output shaft between the first coupling driven gear and the second coupling driven gear.
